(19) United States
(12) Patent Application Publication
(10) Pub. No.: US 2004/0060447 A1
(43) Pub. Date: Apr. 1, 2004

(54) Multiple plate sorption assembly and method for using same

(76) Inventors: Michael Roy Powell, Kennewick, WA (US); Charles J. Call, Albuquerque, NM (US); Douglas M. Smith, Albuquerque, NM (US); Vinayan C. Menon, Wappingers Falls, NY (US); Ezra L. Merrill, Albuquerque, NM (US)

Correspondence Address: Greenberg Traurig, Suite 400E, 2450 Colorado Avenue, Santa Monica, CA, 90404, US

(21) Appl. No.: 10/398,594

(22) PCT Filed: Oct. 10, 2001
(86) PCT No.: PCT/US01/31798

(51) Int. Cl. B01D 53/02

(52) U.S. Cl. 96/154

(57) ABSTRACT

Disclosed is a sorbent device that includes a and sorbent assembly containing a plurality of layered sorbent plates. Each sorbent plate has opposing sorbent surfaces formed of a layer of a sorbent material affixed to each side of a planar support sheet. The sorbent plates are layered so that each of the opposing sorbent surfaces is adjacent to one of the opposing sorbent surfaces on another of the sorbent plates and spaced apart from one another to form a channel between each pair of adjacent opposing sorbent surfaces. An inlet valve provides fluid communication between the sorbent assembly and a gas source, while a two-way outlet valve fluid communication between the sorbent assembly and a processor or a vacuum pump.

### BACKGROUND OF THE INVENTION

1. Field of the Invention

The present invention relates to the chemical arts. In particular, the present invention relates to a device for the efficient adsorption and desorption of an adsorbable fluid and a method for using the device.

2. Discussion of the Related Art

When separating out a liquid from a mixture of gas and vapor, such as separating out water from atmospheric air, efficient separation is possible using well-known methods of condensation, unless the relative humidity is less than about 50% at which point condensation of the water vapor from atmospheric air is so inefficient as to be practically unacceptable.

Alternatively, separation of gas/vapor mixtures or gas mixtures is often accomplished using adsorption. Adsorption is widely practiced and examples include drying air, removing hydrocarbons for vehicle emission systems, and separating chemicals during chemical production. Other examples include purification of intake, circulating, or exhaust air to remove toxic or odiferous gases, and the like; solvent recovery from air leaving an evaporation chamber (used for spray painting, textile dry-cleaning, polymer processing, and the like); fractionating gases, such as low-molecular-weight hydrocarbon gases and industrial gases; removing liquid sulfur, ammonia, hydrogen disulfide, and sulfur-containing hydrocarbons from petroleum-based fuels; extracting water vapor from air; and desorption processes involving the drying of particulate solids.

In adsorption, a stream of the gas or gas/vapor mixture flows over a highly porous solid (the adsorbent) and at least one component of the stream (the adsorbate) is selectively adsorbed onto the internal surface of the adsorbent. With regeneratable adsorption devices, after the capacity of the adsorbent is filled, the adsorbate is desorbed from the adsorbent surface. The adsorption device can then be repeatedly cycled between the adsorption and the desorption steps.

Adsorption involves a phase change where the adsorbate transforms from a gas or vapor to a liquid-like state. Conversely, desorption involves the phase change from the liquid-like state to the gas or vapor. It is well known that adsorption is an exothermic process, while desorption is an endothermic process.

Conventionally, adsorption is performed in beds of closely packed adsorbent pellets. The adsorbent temperature increases throughout the exothermic adsorption step in the packed bed, because heat removal from a packed bed is very slow. For large packed beds, the rate of heat removal is so slow that the adsorption step can be considered to be adiabatic. This rise in adsorbent temperature decreases the overall adsorption capacity of the adsorbent. The increase in bed temperature coupled with the pressure drop of the gas or vapor, which occurs as it passes through the bed, increases the cycle time, which in turn exacerbates the temperature increase. In extreme cases, the increase in adsorbent temperature can completely stop adsorption and can even pose a fire and explosion hazard.

These problems are particularly acute for applications for which the adsorbate-adsorbent combination has a high heat of adsorption, such as water-zeolite, and alcohol-zeolite combinations, for systems with concentrated streams, i.e., streams containing greater than about 1 mol % adsorbate, and for large adsorbers for which it is difficult to remove or add energy. Therefore, there is significant interest in devices and methods to mitigate these problems in order to increase adsorbent capacities per adsorbent weight and efficiencies of processes that utilize regeneratable adsorbents.

One approach for increasing adsorptive capacities involves the use of a cooler during the adsorption step, and a heater during the desorption step with the goal of keeping the temperature of the adsorbent constant Some adsorption and adsorbent regeneration processes involve the input of energy in order to cool the adsorbent during the adsorption step and/or to heat the adsorbent during the desorption step. For example, Japanese Patent Application No. 58193718A2 teaches removing heat to cool an incoming high temperature gas mixture using a heat exchanger before an adsorption step and adding the heat back during a desorption step. This improves the adsorptive capacity as well as the efficiency of desorption of a packed bed, but from an efficient energy utilization perspective, most of the heat generated during the adsorption step is wasted.

The concept of attempting to utilize the heats of adsorption and desorption with the goal of altering the temperature of the adsorbent during the adsorption and desorption steps, known as temperature swing adsorption (TSA), is discussed in Japanese Patent Application No. 57024615A2. This patent application teaches using a heat pipe to transfer the heat of adsorption generated in a layer in an adsorption tower to an adjacent layer in a desorption tower through a partition plate. Similarly, Japanese Patent Application No. 4087616A2 teaches employing a heat pipe to transfer heat generated during adsorption from an adsorption tower to a desorption tower. However, adsorption/desorption towers mimic packed beds and the heat transfer from an adsorption tower is extremely slow.

Utilization of heat generated during adsorption in a packed bed during a TSA process using a phase change material (PCM) is taught in U.S. Pat. No. 5,861,050. The adsorption heat is removed using an encapsulated phase change material and then added back to the adsorbent during desorption. World Intellectual Property Organization Patent Application No. 033932A1 teaches utilizing adsorption heat in connection with a recirculating coolant. It is a drawback of the processes described in all of these references that the heat transfer is very inefficient and the cycle time slow. Furthermore, the scale of the devices described in all of these references is large to compensate for the inefficient heat transfer.

Therefore, in light of this background there exists the need for a method and device where efficient utilization of sorption heat in a non-packed bed type device occurs, and remains much simpler in that it does not require a heat pipe or a PCM or a recirculating coolant for heat transfer. The present invention provides such a method.

### SUMMARY OF THE INVENTION

Now in accordance with the invention there has been found a sorbent device and method that provides for a simple and efficient method for removing adsorbates from gas and gas vapor mixtures containing the adsorbates. The device and method provide for the efficient utilization of sorption heat during an adsorption stage and for the efficient regeneration of the adsorbent.

The device includes a gas source for the adsorbate-containing gas or gas vapor mixture and a sorbent assembly containing a plurality of layered sorbent plates. Each sorbent plate has opposing sorbent surfaces formed of a layer of a sorbent material affixed to each side of a planar support sheet. In some embodiments, the sorbent material has a specific surface are of 50 m2/g to 2000 m2/g. And is some embodiments the sorbent material has a thickness of less than 5 mm. Suitable adsorbent materials include hydrophilic surface modified activated carbon. In some embodiments, the support sheet has a thermal conductivity of greater than 0.1 W/mK, while in other embodiments, the support sheet has a heat capacity of from about 25 Btu/ft3 to about 60 Btu/ft3. And in some embodiments, the support sheet has a thickness between 0.0005 inch and 0.02 inch Suitable materials for the support sheet include a polymers, such as polyethylene and polyimides, aluminum, stainless steel, Iconel, nickel or brass.

The sorbent plates are layered so that each of the opposing sorbent surfaces is adjacent to one of the opposing sorbent surfaces on another of the sorbent plates. Additionally, the sorbent layers are spaced apart from one another to form a channel between each pair of adjacent opposing sorbent surfaces. In some embodiments, the spacing between each pair of adjacent opposing sorbent surfaces is less than 10 mm and in some embodiments the spacing is less about 0.1 mm. In some embodiments, the spacing between each pair of adjacent opposing sorbent surfaces is between 10 and 2000 microns.

The sorbent assembly includes at least one gas stream inlet port into the channels and at least one gas stream outlet port out of the channels. An inlet valve provides fluid communication with the gas source and the gas stream inlet port, while a two-way outlet valve provides fluid communication with the gas stream outlet port and in its first position permits fluid communication between the gas stream outlet port and a processor and in its second position permits fluid communication between the gas stream outlet port and a vacuum pump.

### DESCRIPTION OF THE DRAWINGS

FIG. 1 illustrates a cross-sectional view of a sorbent plate.

FIG. 2 illustrates an exploded view of a multiple plate sorbent stack assembly.

FIG. 3 illustrates a sorbent stack device which simultaneously adsorbs and desorbs.

FIG. 4 illustrates a partially cut-away encased sorbent stack.

FIG. 5 illustrates a sorbent stack device which sequentially adsorbs and desorbs.

FIG. 6 is a chart showing a temperature profile of a packed bed device recorded at different times.

FIG. 7 is a chart showing a temperature profile of a packed bed device as a function of time.

FIG. 8 is a chart showing the adsorbent temperature profile as a function of time.

### DETAILED DESCRIPTIONS OF THE PREFERRED EMBODIMENTS

For the purpose of promoting an understanding of the principles of the invention, reference will now be made to certain embodiments and specific language will be used to describe the same. It will nevertheless be understood that no limitation of the scope of the invention is thereby intended, such alterations, further modifications and such applications of the principles of the invention as illustrated herein being contemplated as would normally occur to one skilled in the art to which the invention pertains.

Certain terminology will be used in the following specification for convenience in reference only and will not be limiting. For example, the word “absorption” refers to the occurrence of a substance (e.g., water vapor) penetrating the inner structure of another (the absorbent). Also, the word “adsorption” refers to the occurrence of a substance (e.g., water vapor) being attracted and held onto the surface of another (the adsorbent). The words “absorption” and “adsorption” include derivatives thereof. The word “sorbent” refers to a material that is either an absorbent and or an adsorbent. The phrase “gas mixture” will include mixtures of gas with other gases as well as mixtures of gas with vapor.

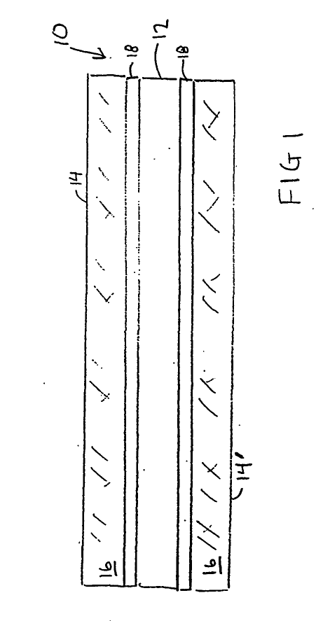

With reference now to the FIG. 1, there is shown a cross-sectional view of a sorbent plate in accordance with the invention. The sorbent plate 10 is constructed of opposing sorbent surfaces 14 and 14′ formed of a thin layer of a sorbent material 16 affixed to each side of a support sheet 12.

In some embodiments, the support sheet 12 has a high thermal conductivity to provide an efficient heat transfer medium. In these embodiments the support sheet 12 preferably has a thermal conductivity greater than about 0.1 W/mK, preferably greater than about 1 W/mK and most preferably greater than about 10/W/mK. Representative high thermal conductivity materials include Iconel Alloy aluminum, stainless steel, and polymers having a high thermal conductivity.

In alternative embodiments, the support sheet 12 has a high heat capacity per unit volume. The support sheet 12 localizes the heat generated during the adsorption part of an adsorption/desorption cycle to the sorbent surfaces 14 and 14′ in order to facilitate efficient heat removal from the sorbent plate 10 during the subsequent desorption step. The support sheet 12 typically has a heat capacity of from about 25 Btu/ft³ to about 60 Btu/ft³. Preferred heat capacities are from about 30 Btu/ft³ to about 50 Btu/ft³ being most preferred. Examples include polyethylene (71 Btu/ft³), polyimides (27 Btu/ft³), aluminum (42 Btu/ft³), stainless steel (60 Btu/ft³), nickel (61 Btu/ft³) and brass (49 Btu/ft³).

The thickness of the support sheet 12 is typically about 0.0005 inch to about 0.02 inch. Thicknesses of from about 0.0005 inch to about 0.01 inch are preferred, with thickness of from about 0.0005 inch to about 0.03 inch being most preferred.

The sorbent material 16 has a high specific surface area and a low mass. The specific surface area of the sorbent material 16 is typically from about 50 m²/g to about 2000 m²/g. Preferred sorbent materials 16 are granular materials having a specific surface area of from about 100 m²/g to about 1000 m²/g, most preferably from about 250 m²/g to about 750 m²/g.

Representative sorbent materials include activated carbon and zeolites, with hydrophilic surface modified activated carbon adsorbents being preferred. For separating out water from atmospheric air a hydrophilic surface modified activated carbon adsorbent, such as M3 type 3A available from EM Science and as disclosed in U.S. patent application Ser. No. 09/091,371, filed Oct. 18, 2000, are preferred.

In some embodiments, the sorbent layers 14 and 14′ have an interconnected pore network to facilitate mass transport in and out of the adsorbent layer. The pore size in the network is typically from about 10 microns to about 500 microns, preferably from about 15 microns to about 200 microns, and more preferably from about 25 microns to about 100 microns.

The sorbent material 16 is affixed to each side of the heat transfer support sheet 12 using any suitable method. A preferred method to adhere the sorbent material 16 is to use of a thin layer of an adhesive or glue 18. Suitable glues and/or adhesives include acrylic or silicone based adhesives. Type 2216 and Type 965, acrylic type, available from 3M are preferred.

Each layer of sorbent material 16 typically has a thickness of less than 5 mm, preferably less than about 0.5 mm, more preferably less than about 0.1 mm. If the layer is too thick heat transfer efficiency becomes difficult.

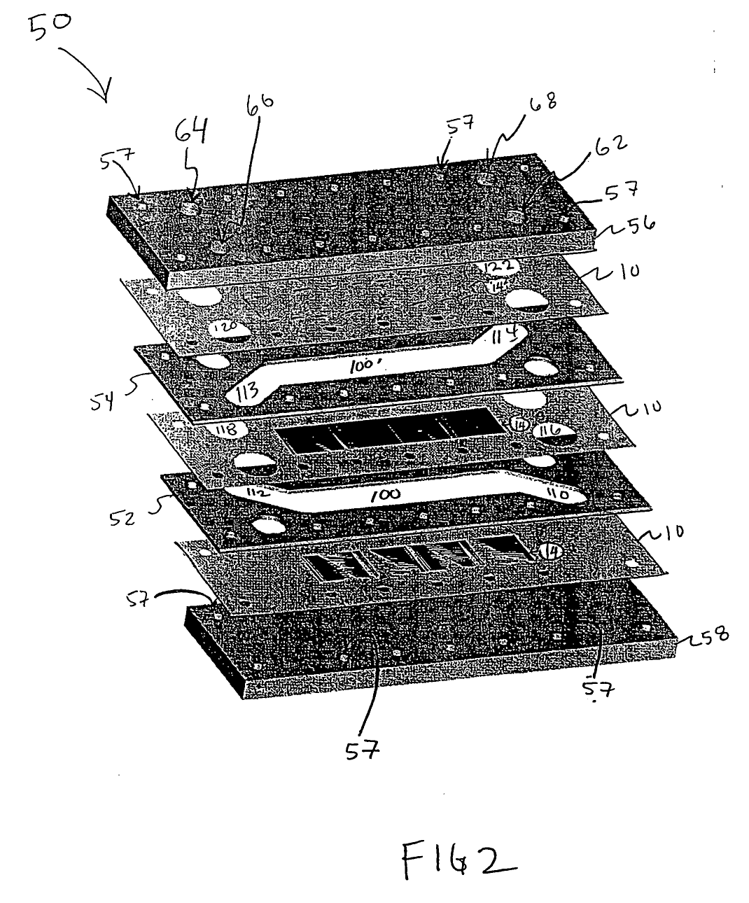

FIG. 2 shows an exploded view of a multiple plate sorbent stack 50 assembly. The assembly includes a plurality of planar sorbent plates 10, containing sorbent surfaces 14 and 14′, (only one sorbent surface shown) layered between a top piece 56 and a bottom piece 58. Three sorbent plates are shown in FIG. 2, for clarity and not as a limitation on the number of sorbent plates that can be used to form the sorbent stack.

The sorbent surfaces 14 and 14′ of adjacent sorbent plates 10 are separated using gaskets 52 and 54 made of a lightweight material having low thermal conductivity. Representative materials for construction of the gaskets include polymers such as rubberized elastomers and RTV gaskets. The assembly is secured using a plurality of bolts (not shown) which are positioned in a plurality of bolt holes 57 aligned through the top and bottom pieces 56 and 58, the sorbent plates 10 and the gaskets 52 and 54.

Together, the sorbent surfaces 14 and 14′ and the gaskets 52 and 54 define alternating channels 100 and 100′. The spacing between the surfaces 14 and 14′ depends on the parameters of the system including variables such as the nature, temperature and quantity of the adsorbate, and the dimensions of each sorbent plate 10. Typically the spacing is less than about 10 mm and in some embodiments is less than about 0.1 mm.

In some embodiments, the spacing is on a meso-scale, i.e., between about 1 and 2000 microns. In the case of adsorbates, such as humid air at 80° C., 1 atm pressure and 80°/relative humidity, the benefits of meso-scale spacing include a reduced surface area leading to a low-pressure drop compactness of the sorbent stack 50 and high system efficiency.

Gasket 52 includes a first gas stream inlet portion 110 aligned with a first gas inlet stream bore 116 in each of the sorbent plates 10, and a first gas stream inlet port 62 in the top piece 56. Gasket 52 also includes a first gas stream outlet portion 112 aligned with a first gas stream outlet bore 118 in each of the sorbent plates 10 and a first gas stream outlet bore 64 in the top piece 56. Thus, a first gas stream flow path is formed in the sorbent stack assembly 50 in through the inlet port 62, through the inlet bores 116, through the channel 100, through the outlet bores 118, and out through the outlet port 64.

Gasket 54 includes a second gas stream inlet portion 112 aligned with a second gas inlet stream bore 120 in each of the sorbent plates 10, and a second gas stream inlet port 66 in the top piece 56. Gasket 54 also includes a second gas stream outlet portion 114 aligned with a second gas stream outlet bore 122 in each of the sorbent plates and a second gas stream outlet port 68 in the top piece. Thus, a second gas stream flow path is formed in the sorbent stack assembly 50 in through inlet port 66, through the inlet bores 120, through the channel 100′, through the outlet bores 122, and out through the outlet port 68.

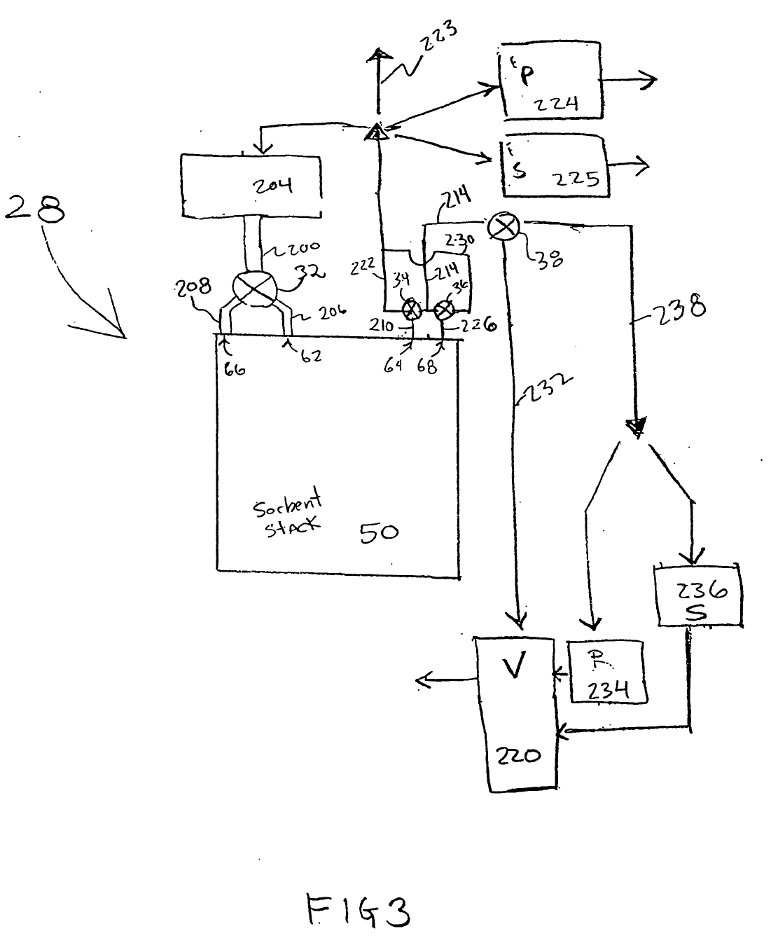

Shown in FIG. 3 is a block diagram of a sorbent device 28 that includes the multiple plate sorbent stack 50 and is of especial use with sorbent surfaces having a high thermal conductivity. A conduit 200 connects gas supply 204 to a two-way inlet valve 32 for directing the gas mixture stream GM through conduit 206 to the first inlet port 62 or through conduit 208 to the second inlet port 66.

A conduit 210 connects the first outlet port 64 to a first two-way outlet valve 34 connected to conduit 214 leading to a vacuum pump 220 and to a conduit 222 acting as an exhaust vent, or leading to a processor 224, storage vessel 225 or back to the gas supply 204. Similarly, a conduit 226 connects the second outlet port 68 to a second two-way outlet valve 36 connected to conduit 214 leading to the vacuum pump 220 and a conduit 230 leading to the processor 224, the storage vessel or the gas supply 204.

In operation, in first step, the two-way inlet valve 32 is set to direct the gas mixture stream GM through conduit 206 to the first inlet port 62. The first two-way exit valve 34 is set to direct the contents of channel 100 (not shown) through conduit 222, as exhaust, or to the processor 224, storage vessel 225, or back to the sorbent stack 50 by reintroduction as gas supply 204. The second two-way exit valve 36 is set to cause the contents of channel 100′ (not shown) to be removed through conduit 226 under reduced pressure created by the vacuum pump 220. In the embodiment shown in FIG. 3, the flow through the two channels is a counter current flow. In alternative embodiments, the flow is a cross flow or a parallel flow.

During the first step, the gas mixture GM stream flows from the gas supply 204 (which may include a blower or other similar device to impart velocity to the gas mixture stream) through channel 100, where the adsorbate is adsorbed on adjacent sorbent surfaces 14′ (not shown). The desorbed gas supply (an exhausted stream from the sorbent stack 50) then flows from channel 100 (not shown) to processor 224. At the same time, the reduced pressure created by vacuum pump 220 causes channel 100′ to be evacuated, thereby desorbing any adsorbate previously adsorbed on the sorbent surfaces 14 and regenerating the sorptive surfaces. In some embodiments, the evacuated adsorbate is directed towards a third two-way exit valve 38 which is set to cause the evacuated adsorbate to be removed through a conduit 232, transported to an adsorbate processor 234 or to a storage vessel 236 through a conduit 238.

Whether the sorptive capacity of the sorbent surface 14 has been reached or the sorbent surface 14′ regenerated can be monitored by any suitable method. Representative methods include monitoring the feed gas flow rate, monitoring the temperature of the sorbent plates 10 or monitoring the concentration of the adsorbate, for example, monitoring the humidity of the gas mixture GM after it has passed over the surface. In some embodiments, the duration of the first step is based on a predetermined time interval. The time interval should be sufficient to cause at least a portion of the adsorbate to be adsorbed.

Once the sorptive capacity of the sorbent surface 14 has been reached and/or the sorptive capacity of the opposite sorbent surface 14′ regenerated, a second step is begun. During the second step, the two-way inlet valve 32 is set to direct the gas mixture stream GM through conduit 208 to the second inlet port 66. The first two-way exit valve 34 is set to cause the contents of channel 100 to be removed from the sorbent stack 50 through conduit 214 under reduced pressure created by the vacuum pump 220. (Those contents may then be further processed or stored as previously discussed). The second two-way exit valve 36 is set to direct the contents of channel 100′ to flow through conduit 230 and is vented as exhaust 223, or either transported to the processor 224, a storage vessel 225, or reintroduced to the sorbent stack 50 through the gas supply 204.

During the second step, the gas mixture GM stream flow from the gas supply 204 through channel 100′, where the adsorbate is adsorbed on adjacent sorbent surfaces 14 (not shown). The desorbed gas supply then flows from channel 100′ to the processor 224. Meanwhile, the reduced pressure created by the vacuum pump 220 causes the channel 100 to be evacuated, resulting in the desorption of the adsorbate from the sorbent surfaces 14′

The cycle is then repeated using the original valve settings causing the adsorbate to be adsorbed on the regenerated surface 14′ and causing surface 14 to be regenerated. It is an advantage of the invention that the heat generated at one sorbent surface 14 during adsorption is transferred through the heat transfer support material 12 to the opposite sorbent surface, thus reducing the temperature of the first surface and increasing the temperature of the other surface, so as to enhance the efficiency of both the adsorption and desorption steps. To facilitate heat transfer the temperature difference between the two surfaces is generally between 0° and 10° C., preferably between 0°, and 5° C., and most preferably between 0 and 3 C.

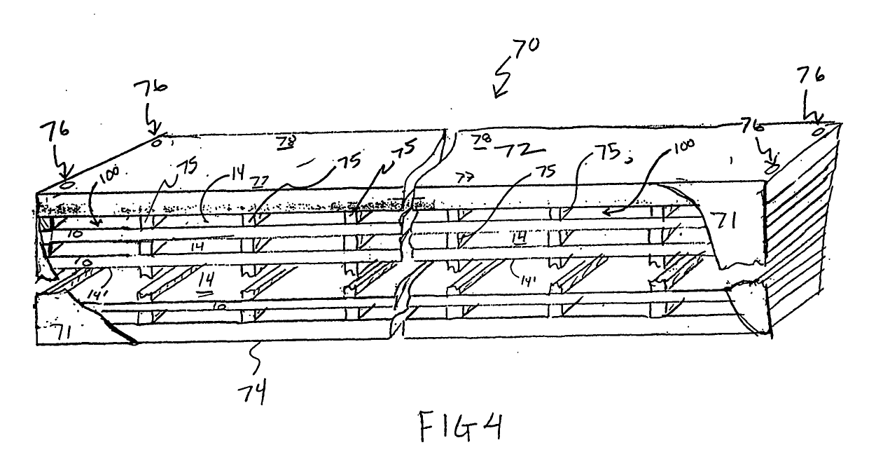

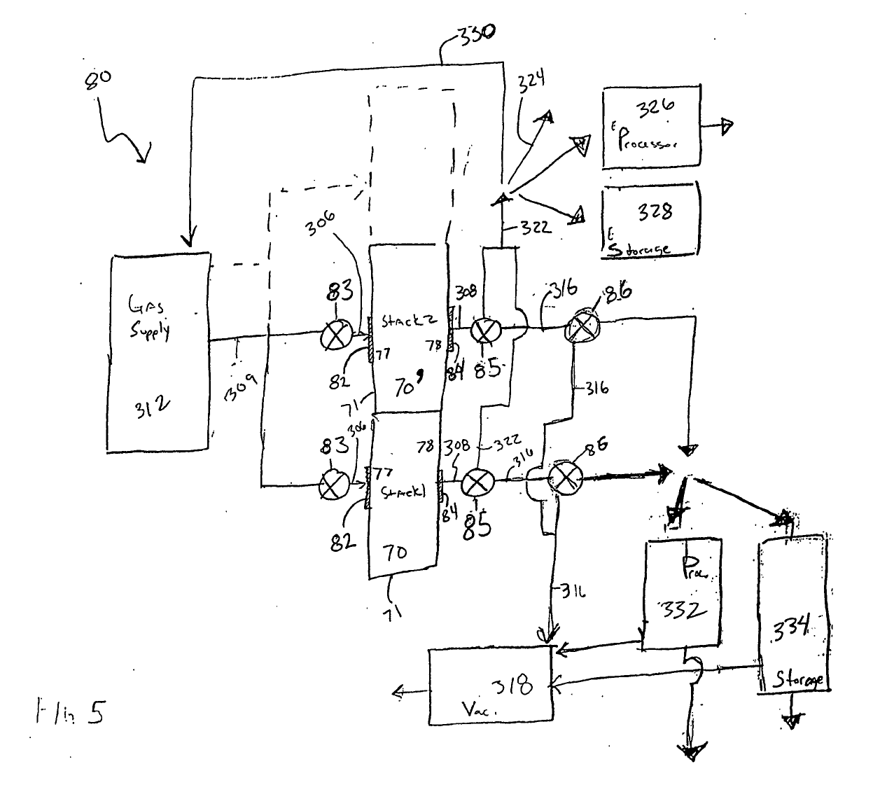

FIG. 4 shows a front perspective view of a multiple plate sorbent stack assembly 70, partially cut away. A casing 71 with inlet and outlet ports (shown in FIG. 5) surrounds the sorbent stack The assembly includes a plurality of planar sorbent plates 10, containing sorbent surfaces 14 and 14′, layered between a top piece 72 and a bottom piece 74. Three sorbent plates are shown in FIG. 4 for clarity, and not as a limitation on the number of sorbent plates that can be used to form the sorbent stack. Spacers 75 separate the sorbent surfaces 14 and 14′ of adjacent sorbent plates 10. The assembly is secured using a plurality of bolts (not shown) which are positioned in a plurality of bolt holes 76 aligned through the top and bottom pieces 72 and 74, the sorbent plates 10 and spacers 75.

The spacers are preferably made of a lightweight material having low thermal conductivity. Typical spacer 75 width is from about 2-10 millimeters Representative materials include plastic materials, such as polystyrene. In a typical sorbent stack used for adsorbing water vapor from atmospheric air, to produce 1 liter of water/hour, the dimensions of the sorbent plate are one inch wide from front side 77 to back side 78 and about nine inches long.

Together, the sorbent surfaces and the spacers 75 define a plurality of channels 100. The spacing between the surfaces 14 and 14′ will depend on the parameters of the system including variables such as the nature, temperature and quantity of the adsorbate, and the dimensions of each sorbent plate 10. Typically, the spacing between the sorbent surfaces 14 and 14′ produced by interposing the spacers 75 is less than about 10 mm and in some embodiments is less than about 0.1 mm.

In some embodiments, the spacing is on a meso-scale, i.e., between about 1 and 2000 microns. In the case of adsorbates, such as humid air at 80° C., 1 atm pressure and 80% relative humidity, the benefits of meso-scale spacing include a reduced surface area leading to a low-pressure drop, compact size and high system efficiency.

FIG. 5 illustrates a sorbent device 80 that includes a first and a second of multiple plate sorbent stacks 70 and 70′ each in a casing 71 and is of especial use with sorbent surfaces having a low thermal transfer coefficient. An inlet 82 port communicates through the casing 71 with the front side 77 of the sorbent stack 70 and is connected by a conduit 306 to an inlet valve 83. An outlet port 84 is placed opposite the inlet port 82 and communicates through the casing 71 with the backside 78 of the sorbent stack 70, and a conduit 308 connects the first two-way exit valve 85 with the outlet port 84.

For clarity only, two sorbent stacks 70 and 70′ are shown. However, this should not be viewed as a limitation on the number of sorbent stacks which could be connected to the device 80.

The inlet valves 83 are also connected by a conduit 309 to the gas supply 312, which may include a blower or other similar device to impart velocity to the gas mixture GM stream. The two-way exit valves 85 are connected by conduit 316 to second two-way valves 86 which connect to a vacuum pump 318 or by conduit 322 to an exhaust vent 324, a processor 326, storage vessel 320 or another conduit 330 which directs the desorb gas supply back into the gas supply 312.

Now examining the operative adsorption/desorption cycle with a single sorbent stack 70 configuration, the first step of a cycle begins with the sorbent surfaces 14′ having a high unspent sorptive capacity. In the first step, the inlet valve 83 is opened and the gas mixture GM stream is directed through conduit 309 to the inlet valve 83 and through the inlet port 82. The two-way exit valve 85 is set to direct the gas mixture stream through conduit 322 to either the exhaust vent 324, the processor 326, the storage vessel 328 or into a conduit 330 and back to the gas supply 312.

During the first step, the gas mixture GM stream flows from the gas supply 312 through channels 100 (not shown), where the adsorbate is adsorbed on adjacent sorbent surfaces 14 and 14′ (not shown). The desorbed gas supply then flows from channel 100 through the outlet port 85. The flow of the gas mixture GM stream is maintained until the sorptive capacity of the sorbent surfaces 14′ is spent or for a time sufficient to cause at least a portion of the adsorbate to be adsorbed.

Whether the sorptive capacity of the sorbent surface 14′ has been reached can be monitored by any suitable method. Representative methods include monitoring the feed gas flow rate, monitoring the temperature of the sorbent plates 10 or monitoring the concentration of the adsorbate, for example, monitoring the humidity of the gas mixture GM stream after it has passed through the sorbent stack 70. In some embodiments, the duration of the first step is based on a predetermined time interval.

The time interval of the adsorptive first step for a fixed size stack of sorbent plates is typically from about 1 to about 600 seconds, preferably from about 1 to about 60 seconds, and most preferably from about 1 to about 5 seconds. However, that time interval is based on a number of variables, which can affect the sorptive capacity and thereby alter the time interval. The variables include the nature of the adsorbent, including its heat of adsorption and its thermal mass, the gas mixture, the flow rate, the concentration of adsorbate, pressure, and temperature.

Once the sorptive capacity of the sorbent surface 14 has been reached, a second step in the cycle is begun. In the second step, the inlet valve 83 is closed and the two-way exit valve 85 is set to cause the contents of channels 100 to be removed through conduit 308 under reduced pressure created by the vacuum pump 318. During the second step, the reduced pressure created by the vacuum pump 318 causes the channels 100 to be evacuated, resulting in the desorption of the adsorbate from the sorbent surfaces 14′. The evacuated adsorbate is either exhausted out through the vacuum pump 318, or transported to a processor 332, storage vessel 334 or secondary processor (not shown).

The vacuum is maintained until the capacity of the sorbent surfaces is regenerated, typically from about 1 to about 600 seconds, preferably from about 1 to about 60 seconds, and more preferably from about 1 to about 5 seconds. The precise interval may be affected by a number of variables including flow rate, temperature, pressure of the gas mixture, as well as the partial pressure and concentration of the adsorbate (e.g., relative humidity).

Whether the sorptive capacity of the sorbent surfaces has been reached or the sorbent surfaces regenerated can be monitored by any suitable method. Representative methods include monitoring the feed gas flow rate or monitoring the concentration of the adsorbate, for example, monitoring the humidity of the gas mixture GM stream after it has passed over through the sorbent stack 70. As discussed within, in some embodiments, the duration of the first step is based on a predetermined time interval.

The operative adsorption/desorption cycle in a multiple sorbent stack 70 device utilizes the same two step cycle of the single sorbent stack operation described above. The typical adsorption/desorption cycles merely take place concurrently at different stages, which may improve the overall energy efficiency and output of the system.

For example, in a two sorbent stack device (FIG. 5), while the first stage of the cycle occurs in one sorbent stack 70 the second stage of the cycle can occur in the other sorbent stack 70′. By staggering the cycle times for each sorbent stack 70 & 70′ the gas supply 312 can be shared to supply the gas mixture GM stream to either sorbent stack 70 and 70′ dependant on whether the corresponding inlet valve 83 is opened or closed. During the desorption (second stage) the sorbent stacks 70 and 70′, alternatively share the vacuum, 318, processor 332 and storage vessel 334.

The multiple plate sorbent devices in accordance with the invention are useful in removing both adsorbable gases from gas mixtures and adsorbable vapors from mixtures of gas and vapors. This invention is applicable for adsorption-based processes involving drying of gas streams laden with vapors having high heats of condensation. In general, the heat of adsorption is always greater than the heat of vaporization/condensation. For example, a process involving adsorption of water vapor would typically release a significant energy because of the high heat of water vapor condensation that corresponds to ˜2.3 kJ/g. Further, the heat of adsorption of water vapor on NaA zeolite is ˜4.2 kJ/g. This invention is also applicable for adsorption-based efficient processes involving concentrating vapors from a carrier gas stream.

Representative applications of the inventive devices include removing hydrocarbons from vehicle emission systems, separating chemicals during chemical production, purifying intake, circulating or exhaust air to remove toxic or odiferous gases, and the like; recovering solvents from air leaving an evaporation chamber (used for spray painting, textile dry-cleaning, polymer processing, and the like), fractionating gases, such as low-molecular weight hydrocarbon gases, and industrial gases; and desorption processes involving drying of particulate-solid raw material. The method is especially useful in removing liquid sulfur, ammonia, hydrogen disulfide, and sulfur-containing hydrocarbons from petroleum-based fuels, and extracting liquid water from atmospheric air with low relative humidity.

### EXAMPLES

### Comparative Example

Nitrogen gas was flown through a packed bed containing 1.84 g of a hydrophilic surface modified activated carbon adsorbent at 5 lit/min for 0.5 h in order to remove any adsorbed species at room temperature. The size of the adsorbent granules was ˜1 mm. The cylindrical packed bed was ˜2.3 inches long and four thermocouples were placed along the axis ˜0.75 inches apart.

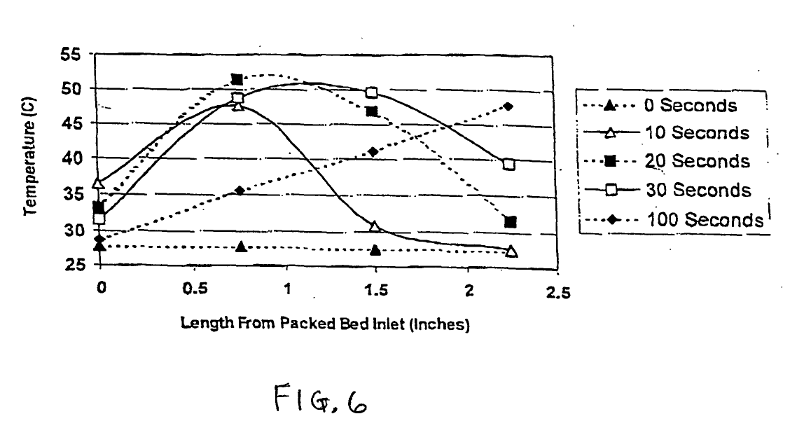

With the nitrogen flow being shut off, air containing 50% relative humidity at inlet and at 5 lit/min was flown through the packed bed. The temperature profile along the axis of the packed bed was recorded at different times and is shown in FIG. 6. A maximum temperature increase of ˜25 C was observed from this figure as a result of water vapor adsorption. Further, this figure also depicts the slow heat transfer kinetics occurring in the packed bed. The temperature profile as a function of time recorded by the four thermocouples is shown in FIG. 7.

### Example 1

An adsorption/desorption plate in accordance with the inventions constructed as follows. A layer of about 0.23 g of hydrophilic surface modified activated carbon adsorbent granules were adhered to each side of a 1 inch by 5 inch and 0.003 inch thick aluminum sheet using a clear epoxy. The size of the adsorbent granules was in the range of 0.09-0.25 mm.

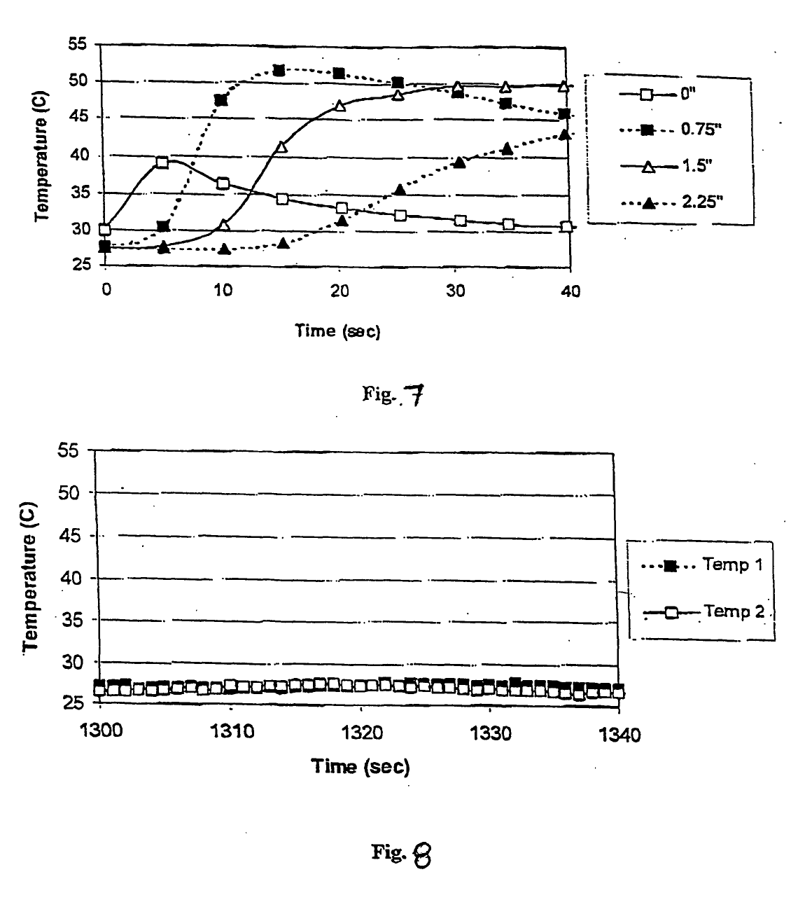

Air containing 50% relative humidity was flown over on side of a sorbent plate 10 while simultaneously desorbing (outgassing) the other side of the sorbent plate 10 using vacuum. The flow rate of air per BET surface area of the adsorbent was maintained as in the Comparative Example 1. This corresponded to an airflow rate of 0.5 lit/min. The adsorbent temperature profile as a function of time recorded by two thermocouples placed on both sides of the sorbent plate 10 is shown in FIG. 8. The legend Temp 1 corresponds to the adsorption side while the legend Temp 2 corresponds to the desorption (outgassing) side. The maximum sorbent temperature change on side of the sorbent plate was within 2 C. Within the experimental error the temperature on both sides are almost similar, and does not change with time thus approaching near-isothermal conditions.

All of the references cited herein, including patents, patent applications, and publications, are hereby incorporated in their entireties by reference. While the invention has been illustrated and described in some detail in the foregoing desorption and Figure, the same is to be considered as illustrative and not restrictive in character, it being understood that only the preferred embodiments have been illustrated and described and that all changes and modifications that come within the spirit of the invention are desired to be protected.

What we claim is:

1. A sorbent plate comprising opposing sorbent surfaces formed of a layer of a sorbent material having a thickness of less than 5 mm affixed to each side of a planar support sheet

2. The sorbent plate in accordance with claim 1 wherein the support sheet has a thermal conductivity of greater than 0.1 W/mK.

3. The sorbent plate in accordance with claim 1 wherein the support sheet has a heat capacity of from about 25 Btu/ft3 to about 60 Btu/ft3.

4. The sorbent plate in accordance with claim 1 wherein the support sheet has a thickness of 0.0005 inch to 0.02 inch.

5. The sorbent plate in accordance with claim 1 wherein the support sheet is made of a polymer, aluminum, stainless steel, Iconel, nickel or brass.

6. The sorbent plate in accordance with claim 1 wherein the sorbent material has a specific surface are of 50 m2/g to 2000 m2/g.

7. The sorbent plate in accordance with claim 1 wherein the sorbent material

8. The sorbent plate in accordance with claim 1 wherein the sorbent material is a hydrophilic surface modified activated carbon.

9. A sorbent plate comprising opposing sorbent surfaces formed of a layer of a sorbent material made of a hydrophilic surface modified activated carbon, having a thickness of less than 5 mm, and a specific surface are of 50 m2/g to 2000 m2/g affixed to each side of a planar support sheet made of a polymer, aluminum, stainless steel, Iconel, nickel or brass and having a thickness of 0.0005 inch to 0.02 inch.

10. The sorbent plate in accordance with claim 9 wherein the support sheet has a thermal conductivity of greater than 0.1 W/mK.

11. The sorbent plate in accordance with claim 9 wherein the support sheet has a heat capacity of from about 25 Btu/ft3 to about 60 Btu/ft3.

12. A sorbent assembly comprising
a plurality of layered sorbent plates each sorbent plate having opposing sorbent surfaces formed of a layer of a sorbent material affixed to each side of a planar support sheet, the sorbent plates layered so that each of the opposing sorbent surfaces is adjacent to one of the opposing sorbent surfaces on another of the sorbent plates, the sorbent layers spaced apart from one another to form a channel between each pair of adjacent opposing sorbent surfaces;
at least one gas stream inlet port into the channels; and
at least one gas stream outlet port out of the channels.

13. The sorbent assembly in accordance with claim 12 wherein the spacing between each pair of adjacent opposing sorbent surfaces is less than 10 mm.

14. The sorbent assembly in accordance with claim 12 wherein the spacing between each pair of adjacent opposing sorbent surfaces is less about 0.1 mm.

15. The sorbent assembly in accordance with claim 12 wherein the spacing between each pair of adjacent opposing sorbent surfaces is between 10 and 2000 microns.

16. A sorbent device comprising
a gas source;
a plurality of layered sorbent plates each sorbent plate having opposing sorbent surfaces formed of a layer of a sorbent material affixed to each side of a planar support sheet, the sorbent plates layered so that each of the opposing sorbent surfaces is adjacent to one of the opposing sorbent surfaces on another of the sorbent plates, the sorbent layers spaced apart from one another to form a channel between each pair of adjacent opposing sorbent surfaces;
at least one gas stream inlet port into the channels;
at least one gas stream outlet port out of the channels;
at least one inlet valve in fluid communication with the gas source and the gas stream inlet port;
at least one two-way outlet valve in fluid communication with the gas stream outlet port the two-way outlet valve having a first position to permit fluid communication between the gas stream out let port and a processor and a second position to permit fluid communication between the gas stream outlet port and a vacuum pump.

17. A method for removing an adsorbate from a gas mixture containing the adsorbate comprising the steps of:
(a) passing a stream of a gas mixture containing an adsorbate through a plurality of channels in a gas assembly, the gas assembly including a plurality of layered sorbent plates each sorbent plate having opposing sorbent surfaces formed of a layer of a sorbent material affixed to each side of a planar support sheet, the sorbent plates layered so that each of the opposing sorbent surfaces is adjacent to one of the opposing sorbent surfaces on another of the sorbent plates and spaced apart from one another to form the plurality of channels between the pairs of adjacent opposing sorbent surfaces for a time sufficient to cause at least a portion of the adsorbate to be adsorbed on the opposing sorbent surfaces and then (b) removing the adsorbed adsorbate from opposing sorbent surfaces.

18. The method in accordance with claim 17 wherein the adsorbate is removed by reducing the pressure in the plurality of channels.

19. The method in accordance with claim 18 wherein the gas mixture containing the adsorbent is passed through the plurality of channels and the adsorbate is removed from the opposing sorbent surfaces by reducing the pressure in the plurality of channels for a period of time between 1 and 600 seconds.

20. The method in accordance with claim 19 wherein the gas mixture containing the adsorbate is passed through the plurality of channels and the adsorbate is removed by reducing the pressure in the plurality of channels for a period of time between 1 and 60 seconds.

21. The method in accordance with claim 20 wherein the gas mixture containing the adsorbent is passed through the plurality of channels and the adsorbate is removed by reducing the pressure in the plurality of channels for a period of time between 1 and 5 seconds.

22. The method in accordance with claim 18 wherein the gas mixture is atmospheric air and the adsorbate is water.

23. The method in accordance with claim 22 wherein the atmospheric air has a relative humidity of less than 50%.

24. The method in accordance with claim 22 further comprising the step of (c) recovering the water after removing the water from the plurality of channels.
